(19) United States
(12) Patent Application Publication
(10) Pub. No.: US 2022/0403305 A1
(43) Pub. Date: Dec. 22, 2022

(54) A SOAP BAR COMPOSITION FOR ENHANCED DELIVERY OF WATER SOLUBLE BENEFIT AGENT

(71) Applicant: Conopco, Inc., d/b/a UNILEVER, Englewood Cliffs, NJ (US)

(72) Inventors: Ajit Manohar AGARKHED, Thane (IN); Swapnil Ravikant HEGISHTE, Mumbai (IN); Vidula IYER, Bangalore (IN); Jasmeet Kaur KHOKHAR, Delhi (IN); Divya PARUCHURI, Hyderabad (IN); Shailendra PRATAP, Bangalore (IN)

(73) Assignee: Conopco, Inc., d/b/a UNILEVER, Englewood Cliffs, NJ (US)

(21) Appl. No.: 17/774,195

(22) PCT Filed: Nov. 19, 2020
(86) PCT No.: PCT/EP2020/082694

§ 371 Date: May 4, 2022

(30) Foreign Application Priority Data
Nov. 21, 2019 (EP) 19210580.7

(51) Int. Cl. C11D 17/04; C11D 13/26; C11D 9/22; C11D 9/26; C11D 9/10; C11D 9/30

(52) U.S. Cl. CPC C11D 17/048; C11D 13/26; C11D 9/225; C11D 9/26; C11D 9/10; C11D 9/30

(57) ABSTRACT

This invention relates to a soap bar composition which provides enhanced delivery of water soluble skin benefit agents such that the desired activity of the benefit agent is observed for a long time post the wash. This is achieved by absorbing/coating the benefit agent on to specific clays followed by further coating with a hydrophobic material selected from wax or petrolatum.

### FIELD OF THE INVENTION

This invention relates to a soap bar composition which provides enhanced delivery of water soluble skin benefit agents. The invention more particularly relates to a soap bar that is used to wash topical surfaces of the body and yet is able to provide sufficient delivery of water soluble actives on to skin especially cationic actives such that the desired activity of the benefit agent is observed long time post the wash.

### BACKGROUND OF THE INVENTION

Products that are used to clean topical surfaces of the human body are delivered through cleansing compositions. They may be used to clean the hair, face, body or hands. Most of these compositions comprise anionic surfactants either made from natural sources like soaps or could be of synthetic origin. Such compositions are also used to deliver benefits other than cleansing like moisturisation, skin lightening, anti aging, anti inflammatory, conditioning or antimicrobial benefits. Many antimicrobial actives have also been included in such cleansing composition like trichlorocarbanilide, triclosan, chloroxylenol, benzalkonium chloride, etc. Actives having cationic charges are considered to be highly effective as an antimicrobial active. Due to the charge neutralisation of such actives in an anionic based surfactant system, it has been a challenge to include cationic actives in such products. It is also a challenge to ensure deposition of water soluble actives in sufficient amounts through such compositions as they generally tend to get washed off with the rinse water. Compounds like polymeric cationic actives which have high charge density are even more difficult to incorporate in such systems.

Soap bars that are claimed to deliver actives to skin have been disclosed before. US2005003975 (P&G) discloses perfume compositions comprising defined high impact accords and personal cleansing compositions, especially soap bars, comprising those perfume compositions are provided. In a preferred aspect, the perfume compositions are encapsulated in starch or the like so as to release fragrance when exposed to water, such as in the shower.

US2005123574 (Unilever) discloses massaging toilet bar compositions that contain disintegrable agglomerates that provide simultaneous exfoliation and massaging to the skin and hair. Agglomerates are made by treating them with hydrophilic liquids, hydrophobic liquids, or a combination thereof. This treatment makes the agglomerate softer but not so soft as to make it break apart during the manufacture of the bars.

Although the above cited published art discloses agglomorates that claim to deliver actives to skin, they are found wanting in being able to deliver water soluble actives especially cationic compounds though a soap bar, that ensure the desired action is exhibited long after the washing action is complete.

Therefore, there exists a need in the art to provide for enhanced delivery of water soluble or cationic actives in cleansing compositions comprising high amount of anionic surfactants. The present inventors have achieved this by including the actives in or by coating them on a porous clay particle and further providing a coating thereupon with a hydrophobic component like petrolatum or wax. The present inventors have also surprisingly found that the present invention is effective when the coated clay particle is incorporated in a solid cleansing composition like a soap bar and the delivery is not as good when formulated in liquid compositions.

The advantage of the present invention is that such water soluble benefit agents are held separated from other soap bar ingredients with which they may interact during manufacture and storage but become available in sufficiently high amounts when the soap bar is used by a person during personal washing, to ensure effective deposition there upon.

It is thus an object of the present invention to provide for a composition comprising anionic surfactants for enhanced delivery of water soluble skin benefit agents.

It is another object of the present invention to provide for enhanced delivery of cationic antimicrobial actives through such wash off soap bar compositions.

### SUMMARY OF THE INVENTION

According to the first aspect of the present invention there is provided a soap bar composition for enhanced delivery of a water soluble benefit agent comprising
(a) 40 to 80% soap;
(b) a porous clay particle having a water holding capacity in the range of 10 to 50% by weight, coated with a water-soluble benefit agent having a solubility in water at 25° C. of at least 0.001 wt %, and further coated there upon with a hydrophobic material selected from wax or petrolatum.

A second aspect of the present invention relates to a process to prepare coated clay particle, for use in a soap bar composition of the first aspect, comprising the steps of:
(a) Mixing the porous clay particle with an aqueous solution of the water soluble benefit agent;
(b) Drying the porous particle to be substantially free of moisture;
(c) Mixing the dried porous particle in a solution mixture of an organic solvent and the hydrophobic material;
(d) Separating the particulate matter from the solution mixture and drying the particulate matter to prepare the coated particle.

The third aspect of the present invention relates to a method of delivering a water soluble active on to skin comprising the steps of washing the skin with a solution of the soap composition of the first aspect followed by rinsing the skin with water to be substantially free of soap.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description and claims indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated. In other words, in specifying any ranges of values, any particular upper value can be associated with any particular lower value.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method or process relating to the invention) mutatis mutandis.

By a soap bar composition is meant a composition which is in the form of a shaped solid and is used for cleaning topical surface of the body and predominantly includes soap (salt of fatty acid). Such a composition is diluted with water to a solution/dispersion and is generally applied on to the desired topical surface of the body for a period of time from a few seconds to up to several minutes. Thereafter the composition is generally rinsed off with water to leave the surface substantially free of soap. It includes any product applied to a human body for also improving appearance, cleansing, odor control or general aesthetics. The soap bar composition of the present invention may be used to wash hair (like a shampoo or conditioner) or may be used for handwash, facewash or bodywash. It is more preferably used for disinfecting the hand or other parts of the human body or for delivering/depositing other skin benefit agents thereupon.

The present invention relates to a soap bar composition that is formulated to ensure enhanced delivery of water soluble skin benefit agent. The soap bar composition comprises 40 to 80% soap; and a coated porous clay particle. The porous clay particle is so selected as to have a water holding capacity in the range of 10 to 50% by weight.

The means that for every 100 g of the clay particle, it is capable of absorbing or holding 10 to 50 g of water without appearing too wet i.e the water is predominantly absorbed into the pores of the clay. In other words, it appears free flowing even after absorbing water. The clay particle is coated with a water-soluble benefit agent having a solubility in water at 25° C. of at least 0.001 wt %. The waters soluble benefit agent is not necessarily only coated on the external surface of the clay particle. By “coated with” is meant that that water-soluble benefit agent may be partly absorbed into the pores of the clay particles and the rest are coated to form a layer at least partially on the external surface of the clay particle. The clay particle so coated with the water soluble benefit agent is further coated there upon with a hydrophobic material selected from wax or petrolatum.

The soap is preferably C8-C24 soap, more preferably 010-C20 soap and most preferably C12-018 soap. The cation of the soap can be alkali metal, alkaline earth metal or ammonium. Preferably, the cation of the soap is selected from sodium, potassium or ammonium. More preferably the cation of the soap is sodium or potassium, most preferably sodium.

A typical fatty acid blend consists of 5 to 30% coconut fatty acids and 70 to 95% tallow fatty acids by weight of soap. Fatty acids derived from other suitable oils/fats such as groundnut, soybean, tallow, palm, palm kernel, etc. may also be used in other desired proportions.

Soap is present in an amount of 40 to 80%, preferably from 50 to 75% by weight of the soap bar composition.

Any water soluble skin benefit agent which satisfies the water solubility criterion of 0.001 wt % at 25° C. may be used but it is preferably one or more of an antimicrobial cationic active; a water soluble vitamin or derivatives thereof; a water soluble sunscreen; alpha or beta hydroxy acids; or water soluble alkali or alkaline earth metals salts. Of the above actives, the more preferred ones are one or more of an antimicrobial cationic active; a water-soluble vitamin or derivatives thereof; or a water soluble sunscreen. The most preferred active is an antimicrobial polymeric cationic active.

Antimicrobial polymeric cationic active which may be preferably included in the emulsion composition is one or more of poly diallyl dimethyl ammonium chloride (PDADMAC) or chitosan, preferably PDADMAC. PDADMAC is homopolymer of diallyldimethyl ammonium chloride (DADMAC). The preferred PDADMAC molecular weight for use in this invention is in the range of 2,00,000-20,00,000, preferably 4,00,000-6,00,000. It is a cationic polymer with high charge density preferably higher than 2 meq/gm and with a viscosity in the range of 10,000-20,000 mPas. The polymer is available under the trade name of Merquat-100 (INCI: Polyquaternium-6) from Lubrizol Inc. Water soluble vitamin or derivatives thereof which may be included are chosen from one or more of vitamin C, E, B3, B5 or N-methylnicotinamide, more preferably Vitamin B3. Water soluble sunscreen which may be included is chosen from one or more of 2-phenylbenzimidazole-5-sulfonic acid (sold as Enulizole) or ethylhexyl salicylate (sold as Neoheliopan OS). Alpha hydroxy acid which may be included is chosen from one or more of lactic acid, glycolic acid, or salicylic acid preferably lactic acid. The water-soluble benefit agent is preferably included in 1 to 20% by weight of the clay particle.

The water-soluble skin benefit agent is include in and/or coated on a porous clay particle. The clay is preferably one of a smectite class. Preferred clays are kaolin, bentonite or china clay.

Clays are finely ground natural rock or soil material. Based on the physical and chemical nature these clays are further classified into many clay mineral groups. For example, the structure of kaolinite is a tetrahedral silica sheet alternating with an octahedral alumina sheet. The charges within the structural unit are balanced. The molecular formula that is common for the kaolinite group is Al₂Si₂O₅(OH)₄.

Bentonite has an ability to form thixotropic gels with water, an ability to absorb large quantities of water with an accompanying increase in volume of as much as 12-15 times its dry bulk, and a high cation exchange capacity. These cations are exchangeable due to their loose binding and, together with broken bonds (approximately 20% of exchange capacity), give montmorillonite a rather high (about 100 meq/100 g) cation exchange capacity, which is little affected by particle size.

These clays could be procured from companies like English India Clays (EICL), Clariant, Ashapura Minehem Ltd., Shree Ram Minerals etc.

The porous clay particle is included in 1 to 25%, preferably 2 to 10% by weight of the soap bar composition.

The porous clay particle incorporated/coated with the water-soluble skin benefit agent is then further coated with a hydrophobic material selected from wax or petrolatum, preferably petrolatum.

Any of the following types of waxes i.e. microcrystalline wax, beeswax or carnauba may be used. Microcrystalline wax consists of petroleum-derived plastic material that differs from paraffin waxes in having much finer and less-distinct crystals and higher melting point and viscosity. The melting-point range is higher than that of paraffin wax, with commercial grades ranging from 63° to 93° C. Chemically, microcrystalline waxes consist of saturated aliphatic hydrocarbons.

Beeswax is a natural wax produced by honey bees of the genus Apis. Beeswax is a tough wax formed from a mixture of several chemical compounds. An approximate chemical formula for beeswax is C₁₅H₃₁COOC₃₀H₆₁. Its main constituents are palmitate, palmitoleate, and oleate esters of long-chain (30-32 carbons) aliphatic alcohols. Beeswax has a relatively low melting point range of 62 to 64° C.

Carnauba also called Brazil wax or palm wax, is a wax of the leaves of the palm. It consists mostly of aliphatic esters, diesters of 4-hydroxycinnamic acid, ω-hydroxycarboxylic acids, and fatty alcohols. The compounds are predominantly derived from acids and alcohols in the C26-C30 range. Distinctive for carnauba wax is the high content of diesters as well as methoxy cinnamic acid. Melting point is generally in the range of 82-86° C.

Petrolatum which is also known as petroleum jelly is a purified mixture of semi-solid hydrocarbons obtained from petroleum with a carbon chain length of 25 or higher. The petroleum jelly has excellent moisturizing property and has a melting point around 37° C. It is colorless or pale yellow (when not highly distilled), translucent and devoid of taste and smell when pure. It is insoluble/immiscible in water. Petrolatum is also generally known as petroleum jelly. Preferred petrolatum for use in the present invention is one having a slip melting point in the range of 45 to 75° C. The hydrophobic phase may also comprise smaller amounts of other hydrophobic materials like fatty acids, triglycerides, or silicones.

The hydrophobic material is included in 0.1 to 10% by weight of the clay particle.

Other anionic surfactants may optionally be included in the soap bar composition of the invention. They are preferably selected from alkyl ether sulphate, primary alkyl sulphate, secondary alkyl sulphonates, alkyl benzene sulphonates, or ethoxylated alkyl sulphates. The anionic surfactant other than soap which is preferred in the soap bar composition of the invention is an alkyl ether sulphate preferably those having between 1 and 3 ethylene oxide groups, either from natural or synthetic source and/or sulphonic acid. Especially preferred are sodium lauryl ether sulphates. Alkyl polyglucoside may also be present in the composition, preferably those having a carbon chain length between C6 and C16. Preferred compositions may include other known ingredients such as perfumes, pigments, preservatives, emollients, sunscreens, gelling agents and thickening agents. Choice of these ingredients will largely depend on the format of the composition. Water is a preferred carrier. When water is present, it is preferably present in at least 1%, more preferably at least 2%, further more preferably at least 5% by weight of the composition. When water is the carrier, a preferred cleansing composition comprises 10 to 40%, more preferably 12 to 25% by weight water.

The soap bar composition is preferably prepared using the conventional milled and plodded soap making process. In the milled and plodded route, the soap is prepared with high water content and then spray dried to reduce the moisture content and to cool the soap after which other ingredients are added and then the soap is extruded through a plodder and optionally cut and stamped to prepare the final soap bar. The milled and plodded soaps generally have a high TFM in the range of 60 to 80 weight percent. Alternately the soap is prepared by a relatively dry mixing method in a plough share mixer. Thereafter it may be extruded in the conventional manner. Milled and plodded soap bars are also known as extruded soap bars. They are composed of very many different types of soaps. Most soap compositions comprise both water insoluble as well as water soluble soaps. Their structure is generally characterized by a brick and mortar type structure. Insoluble soaps (called bricks) usually consist of higher chain C16 and C18 soaps (palmitate and stearate soap). They are generally included in soap bars to provide structuring benefits i.e they provide shape to the bars. Soap bars also consist of water soluble soaps (which act as the mortar) which are generally unsaturated C18:1 and 18:2 sodium soap (oleate soap) in combination with short chain fatty acids (generally C8 to C12 or even up to C14 soap). Water soluble soaps generally aid in cleaning.

In the soap bar composition of the present invention, the coated clay particles for inclusion in the soap bar composition of the invention are prepared by a process which is described below, in general.

A solution in water of the benefit agent is added into the dried porous clay media slowly and mixed for several minutes e.g. from about 5 minutes to an hour. The particle coated with the benefit agent is then then dried in an oven to substantially bring down the moisture to a low level such that it is free flowing e.g. moisture content from about 1 to 5 wt %. There may be particle agglomeration after this coating step. The agglomerated particles are broken down to desired fine powder size in a particle crusher. The resulting coated powder is mixed in a solution mixture of desired organic solvent in which the hydrophobic material is solubilized. The solvent is recovered from the powder solution via solvent recovery extraction process and the coated clay particle is dried to a free flowing state.

The invention also relates to a method of delivering skin benefit agents to skin comprising the step of applying the composition of the invention on to the desired skin surface. This is followed by substantially removing the soap from the surface after a specified amount of time. Usually people spend about 10 seconds to 2 minutes washing their body parts and it is expected that in this time frame the desired deposition of the actives should have taken place. The time for washing is preferably from 10 second to one minute more preferably from 10 seconds to 30 seconds. The removal of the composition from the surface may be achieved by wiping the composition off the surface using a suitable wipe. Alternately and more preferably it may be achieved by rising the surface with water to be substantially free of the soap. The composition is usually applied to the desired skin surface after diluting the composition with water. The composition may be diluted with water to a concentration of 1 to 50%, preferably 2 to 20% by weight of the diluted solution.

The invention will now be illustrated with the help of the following non-limiting examples.

### EXAMPLES

Soaps bars as given in the table-1 below were prepared:

Example A: Control

Example B: Bar with uncoated clay

Example C: Bar with clay+PDADMAC

### Example 1: Bar with Petrolatum Coated PDADMAC Clay (as Per Invention)

The clay is coated with PDADMAC and then with the petrolatum using a process as given below:

A solution in water of. polydiallyldimethylammonium chloride is added into dried porous clay media (Supershine Plus Kaolin, EICL, India) in sequential manner and mixed for about 45 minutes. The particle coated with the benefit agent is then then dried in an oven to substantially bring down the moisture to a low level of about 2%. Any agglomerated particles are broken down to desired fine powder size in a particle crusher. The resulting coated powder is mixed in a solution mixture of the organic solvent hexane in which the petrolatum is solubilized. The solvent is separated from the coated clay particle and dried to a free flowing state.

TABLE - 1

| | A | B | C | 1 |
|---|---|---|---|---|
| Sodium Palm | 76.5 | 69.5 | 69.5 | 69.5 |
| Kernelate/Sodium Palmate | | | | |
| (15/85) | | | | |
| Sodium C16-18 Olefin | 1.1 | 1 | 1 | 1 |
| Sulphonate | | | | |
| Glycerin | 4.5 | 4 | 4 | 4 |
| Sodium Chloride | 0.7 | 0.6 | 0.6 | 0.6 |
| Clay | 0 | 10 | 9 | 8.9 |
| PDADMAC | 0 | 0 | 1 | 1 |
| Petrolatum | 0 | 0 | 0 | 0.1 |
| Water | To 100 | To 100 | To 100 | To 100 |

The above soap bars were tested for regrowth of S. aureus on Vitro skin, 6 hours after the wash.

The procedure used to measure this is as follows:
a) 5×5 cm² sterile vitro skin was taken in a petri-plate and washed with 2 ml of sterile water before any treatment. After 10 minutes, the water was removed and skin was kept for drying in fresh petri-plate.
b) Skin was dried for 20 minutes. Skin was not over dried and wet half-cut bar was rubbed against the test area in a horizontal pattern for 15 seconds. After 15 seconds, 1 ml of water was added to the VITRO-SKIN with a pipette and spread using an L-spreader to cover the test area for 45 seconds in horizontal and vertical pattern (this will lead to lathering of the soap)
c) After one minute (45+15 seconds), vitro-skin was taken in one hand at 45-degree angle and distilled water (around 20-30 ml) was poured over the skin with the other hand. There should be no soap-traces left on the skin. The skin was then dried for 30 minutes.
d) After 30 minutes of drying, 100 μl of 10⁶ bacterial inoculums (S. aureus) was added and spread using L-shaped spreader. The bacteria were allowed to be adsorbed on the skin-surface well and dried.
e) The treated skin was placed on TSA plate and the was incubated plate for 6 hours at 37-degree incubator. After 6 hours, the treated skin was immediately added to 9 ml BPB neutralizer tube and vigorously shaken for 3 minutes using Griffin shaker to dislodge bacteria from the skin. 10-fold serial dilution was done followed by plating in TSA media

The log cfu/ml remaining is summarized in Table-2 below:

TABLE - 2

| Example | Log cfu/ml |
|---|---|
| A | 6.1 |
| B | 6.4 |
| C | 6.3 |
| 1 | 5.2 |

The data in the Table-2 above indicates that the soap bar as per the invention (Example-1) is an order of magnitude more efficacious than soap bars (Examples B and C) prepared with the same ingredients but without the desired coating configuration.

1. A soap bar composition for enhanced delivery of a water soluble benefit agent comprising:
(a) 40 to 80% soap;
(b) a porous clay particle having a water holding capacity in the range of 10 to 50% by weight, coated with a water soluble benefit agent having a solubility in water at 25° C. of at least 0.001 wt %, and further coated there upon with a hydrophobic material selected from wax or petrolatum.

2. The soap bar composition as claimed in claim 1, wherein the water soluble benefit agent is chosen from at least one of an antimicrobial cationic active; a water soluble vitamin or derivatives thereof; a water soluble sunscreen; alpha or beta hydroxy acids; or water soluble alkali or alkaline earth metals salts.

3. The soap bar composition as claimed in claim 2, wherein said antimicrobial cationic active includes polydiallyl dimethyl ammonium chloride (PDADMAC), said water soluble vitamin includes vitamin B3; said alpha hydroxy acid includes lactic acid and said water soluble alkaline earth metal salt includes calcium chloride.

4. The soap bar composition as claimed in claim 1, wherein the benefit agent is included in 1 to 20% by weight of the clay particle.

5. The soap bar composition as claimed in claim 1, wherein the hydrophobic material is petrolatum.

6. The soap bar composition as claimed in claim 1, wherein said clay is a smectite clay preferably kaolin, bentonite or china clay.

7. The soap bar composition as claimed in claim 1, comprising 0.1 to 10% hydrophobic material by weight of the clay particle.

8. The soap bar composition as claimed in claim 1, wherein the porous clay particle is included in 1 to 25% by weight of the composition.

9. A process to prepare a coated clay particle, for use in the soap bar composition as claimed in claim 1, comprising the steps of:
(a) Mixing said porous clay particle with an aqueous solution of the water-soluble benefit agent;
(b) Drying said porous particle to be substantially free of moisture;
(c) Mixing the dried porous particle in a solution mixture of an organic solvent and said hydrophobic material;
(d) Separating the particulate matter from the solution mixture and drying the particulate matter to prepare the coated particle.

10. The process as claimed in claim 9, wherein said organic solvent is selected from hexane, heptane, octane or carbon tetrachloride.

11. A method of delivering a water soluble active on to skin comprising the steps of washing the skin with a solution of the soap bar composition as claimed in claim 1, followed by rinsing said skin with water to be substantially free of said soap.
